(19) United States
(12) Patent Application Publication
(10) Pub. No.: US 2008/0118895 A1
(43) Pub. Date: May 22, 2008

(54) Device and Procedure for Facilitating the Fitting of a Tooth or Tooth Remnant Template Into the Right Position

(75) Inventor: Izidor Brajnovic, Göteborg (SE)

Correspondence Address: KNOBBE MARTENS OLSON & BEAR LLP, 2040 MAIN STREET, FOURTEENTH FLOOR, IRVINE, CA, 92614, US

(73) Assignee: NOBEL BIOCARE SERVICES AB, Glattbrugg (SE)

(21) Appl. No.: 11/573,196

(22) PCT Filed: Jul. 4, 2005
(86) PCT No.: PCT/SE05/01075

§ 371 Date: Nov. 9, 2007

(30) Foreign Application Priority Data
Aug. 5, 2004 (SE) 0401985-7

(51) Int. Cl. A61C 5/10

(52) U.S. Cl. 433/223

(57) ABSTRACT

A device is provided for facilitating the proper seating of a template onto teeth of a patient for a dental procedure. The template can conform to the teeth of the patient. The template can define at least one upper part which can correspond to a characteristic part of the teeth of the patient. The template can have at least one aperture disposed through the upper part of the template. The aperture can be sized and configured such that the characteristic part of the teeth can emerge at least partially through the aperture when the template is fitted onto the teeth of the patient. The emergence of the characteristic part of the teeth of the patient can thereby provide a visual indication that the device has been properly seated onto the teeth of the patient.

Device and procedure for facilitating the fitting of a tooth or tooth remnant template into the right position.

The present invention relates to a device and procedure for facilitating the fitting into the right position of a template intended for real teeth and/or tooth remnants.

Templates of this kind are used in dental work and are placed into the patient's oral cavity at the affected place on or near teeth/tooth remnants and spaces near the latter. The template can include guide sleeves, with which drills and other instruments are guided, e.g. at the hole uptake for an implant. It should be possible to use the template in a distinct way, irrespective of the position in the patient's oral cavity. There are cases, however, where fitting is difficult to carry out, which can lead to the template ending up in the wrong position. There is thus a need for being able to attain a distinct fitting position for the template and obtain an indication about this. The present invention solves this problem.

What can mainly be regarded as characterizing for a device according to the invention is inter alia the fact that the construction of the template is related to the shape of the affected teeth and/or tooth remnant parts which is obtained from simulation equipment, e.g. plaster model, computer, etc. The template can furthermore be arranged with openings or recesses, at which characteristic parts of the shape emerge. When the template is fitted to the real teeth and/or tooth remnant parts, the right position arises when the characteristic parts of the real teeth and/or tooth remnant parts correspondingly emerge through the openings or recesses and form a visual indication of said right position. A home-in function for the template also arises.

Further developments of the inventive idea for the new device are apparent from the appended claims.

A procedure according to the invention is characterized inter alia by the fact that a model and/or image of the real teeth and/or tooth remnant parts is produced by means of modelling and/or imaging equipment and that the template is produced with the aid of the model or image, as the case may be. The template is furthermore provided with openings or recesses at characteristic parts, e.g. projecting and/or protruding parts, of those parts of the teeth and/or tooth remnant parts which are reproduced by the model or image, as the case may be. The template can finally be fitted to the real teeth and/or tooth remnant parts, which characteristic parts emerging through the openings or recesses give a visual indication of the right position.

Further developments of the inventive idea for the new procedure are apparent from the appended claims.

Through what is proposed above, distinct positions can easily be attained for the template. The visual indication eliminates the need for special equipment for determining the right final position for the template. Conventional production techniques can be used for the template, which only needs to be provided with the recesses, preferably in its upper parts.

The device and procedure proposed at present will be described below with simultaneous reference to the appended drawing, where

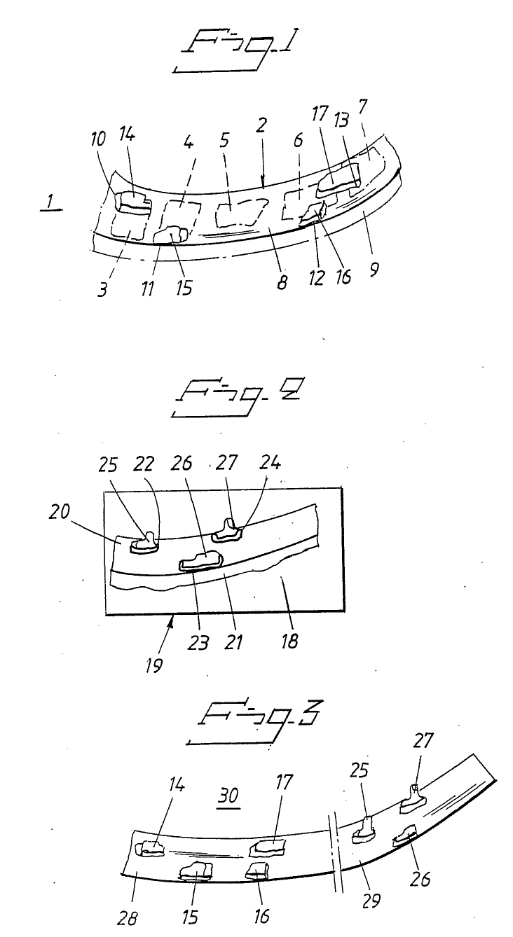

FIG. 1 shows in perspective a template fitted to a plaster model of the patient's oral cavity,

FIG. 2 shows the position of the template on an image, in outline diagram form, and

FIG. 3 shows templates according to FIGS. 1 and 2, and the placing thereof in the patient's oral cavity, in perspective.

In FIG. 1 parts of a plaster model of the patient's oral cavity are indicated as 2. The plaster model indicates teeth and/or tooth remnant parts 3, 4, 5, 6 and 7. On said teeth and/or parts a template is fitted, e.g. a surgical template, which is constructed with sleeves or guide members, not specifically shown, for a drill, not shown, by means of which a hole uptake will be made in a mandible 9 in a known manner. In its upper parts the template is provided with through recesses 10, 11, 12 and 13. Characteristic parts 14, 15, 16 and 17 from the teeth and/or the tooth remnant parts emerge through these. The template can be manufactured in a known manner.

In FIG. 2 an image 18 is generated on a computer/computer screen 19. In this case the template is denoted as 20 and the mandible is denoted as 21. In its upper surface the template is provided with three through recesses 22, 23 and 24, in which characteristic parts 25, 26 and 27 emerge (cf. FIG. 1). The teeth and/or the tooth remnant parts are not shown in this case. The production of the image can be effected with known software. The template can be manufactured in accordance with information from the computer in a known manner.

As shown in FIG. 3 the finished templates 28 and 29 will be fitted in the oral cavity 30 of a patient. The characteristic parts 14, 15, 16 and 17, or 25, 26 and 27, as the case may be, will emerge in the same way through the recesses 10, 11, 12 and 13, or 22, 23 and 24, in the corresponding template. The corresponding templates 28 and 29 are given a facilitated home-in function with the characteristic parts which in addition give a visual indication of the fact that the position homed in on is right, by comparing with a model, image, etc.

The invention is not limited to the embodiments indicated but can be subject to modifications within the scope of the following claims and the inventive idea.

1-10. (canceled)

11. A device for facilitating dental treatment of a patient and ensuring proper positioning of the device on an affected portion of an oral cavity of the patient, the device comprising:
a template being sized and configured to conform to the affected portion of the oral cavity, the template having at least one aperture or recess disposed in the template, the aperture or recess being sized and configured such that at least a portion of a tooth or tooth remnant can emerge at least partially through or into the aperture or recess when the template is fitted onto the affected portion of the oral cavity to provide an indication that the device has been properly seated onto the teeth of the patient.

12. The device of claim 11 wherein the template includes at least three apertures corresponding to respective characteristic parts of teeth or teeth remnants of the patient.

13. The device of claim 11 wherein the template includes four apertures corresponding to respective characteristic parts of teeth or teeth remnants of the patient.

14. A method of preparing a template for ensuring proper seating of the template onto an affected portion of an oral cavity of a patient, the method comprising:
preparing a model of at least a portion of the oral cavity of the patient;
conforming the template to the model, the template defining at least one upper part, the upper part corresponding to the affected portion of the oral cavity of the patient; and
creating at least one aperture or recess in the template, the aperture or recess being disposed through or in the upper part of the template and being sized and configured such that a characteristic part of the teeth can emerge at least partially through or in the aperture or recess when the template is fitted onto the teeth to provide an indication that the device has been properly seated onto the affected portion of the oral cavity of the patient.

15. The method of claim 14 wherein the preparing the model step includes producing the model by one of physical modeling and computer imaging equipment.

16. The method of claim 15 wherein the model is a plaster model.

17. The method of claim 14 wherein the creating at least one aperture or recess step includes creating at least three apertures or recesses corresponding to characteristic parts of the teeth or teeth remnants of the patient.

18. The method of claim 14 wherein the creating at least one aperture or recess step includes creating four apertures or recesses corresponding to respective characteristic parts of teeth of the patient.

19. The method of claim 14 wherein the position of the template on the teeth of the patient is compared with the position of the template on the model.

20. The method of claim 14 wherein the template is given a home-in function during fitting by means of interactions between the apertures or recesses of the template and the characteristic parts of the teeth of the patient.
